(19) United States
(12) Patent Application Publication
(10) Pub. No.: US 2025/0307692 A1
(43) Pub. Date: Oct. 2, 2025

(54) SYSTEMS AND METHODS FOR GENERATING SUMMARIES OF SPORTING EVENTS USING LARGE LANGUAGE MODELS

(71) Applicant: Stats LLC, Chicago, IL (US)

(72) Inventors: Maxim Kalashnikov, Prague (CZ); Michal Bachorik, Tehov (CZ); Ganesh Bonala, Morrisville, NC (US); Jiri Kadlec, Radostice (CZ); Markus Koch, Graz (AT); Lukas Marek, Prague (CZ); Karel Sousek, Nyrsko (CZ); Szymon Szewczyk, Kraków (PL); Erik Swanson, Cary, NC (US)

(73) Assignee: Stats LLC, Chicago, IL (US)

(21) Appl. No.: 18/618,580

(22) Filed: Mar. 27, 2024

(51) Int. Cl. G06N 20/00

(52) U.S. Cl. CPC G06N 20/00

(57) ABSTRACT

Techniques for generating textual content relating to sporting events using generative machine learning models are disclosed. For example, a machine-learning environment receives, from a client device, a request to generate textual content relating to a sporting event. The environment obtains relevant data and generates a prompt, which is provided to one or more generative machine learning models. In turn, the models output textual content relating to the event. The content may be provided to the client device.

### TECHNICAL FIELD

Various aspects of the present disclosure relate generally to machine learning for sports applications, and more specifically, but without limitation, to using machine learning models to automatically generate textual information relating to sporting events.

### INTRODUCTION

Machine learning techniques can be used to analyze sports data and make predictions. But relying solely on manual commentary for sports programs, or live broadcasts, poses certain challenges and limitations that may impact the timeliness, quality, and usefulness of content.

Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques described herein relate to a method for generating textual summaries using one or more machine learning models, the method including: receiving, from a client device, a request for a summary of one or more sporting events; accessing, from a database, one or more database records including sports related data that is associated with the one or more sporting events; formulating, from the one or more database records, a machine learning model prompt, wherein the machine learning model prompt includes (i) instructions readable by the one or more machine learning models and (ii) sports related data from the one or more database records; providing the machine learning model prompt to the one or more machine learning models; receiving, from the one or more machine learning models, an initial textual summary of the one or more sporting events; providing, to an editorial machine learning model, the initial textual summary, wherein the editorial machine learning model is trained to verify the initial textual summary; receiving, from the editorial machine learning model, a revised textual summary; and outputting the revised textual summary to the client device.

In some aspects, the techniques described herein relate to a method, further including: providing, to an additional machine learning model, a model text having a style; and receiving, from the additional machine learning model, a style summary representing the style of the model text; and providing the style summary to the machine learning model prompt prior to providing the machine learning model prompt to the one or more machine learning models.

In some aspects, the techniques described herein relate to a method, wherein the editorial machine learning model is trained to verify factual accuracy of text, and wherein the editorial machine learning model identifies and corrects one or more factual inaccuracies in the initial textual summary.

In some aspects, the techniques described herein relate to a method, wherein the request includes preferences for one or more of a length or format of the summary, the method further including, adding the preferences to the machine learning model prompt prior to providing the machine learning model prompt to the one or more machine learning models.

In some aspects, the techniques described herein relate to a method, wherein the sports related data includes tracking data that is generated based on a broadcast feed of the one or more sporting events, wherein the tracking data includes mathematical representations of one or more of positional information, object information, body pose information, or trend information.

In some aspects, the techniques described herein relate to a method, further including identifying, in the database, one or more preferences associated with a user of the client device; and providing the preferences to the machine learning model prompt prior to providing the machine learning model prompt to the one or more machine learning models.

In some aspects, the techniques described herein relate to a method, wherein the request includes preferences for including a first request for a style and a second request for a length, the method further including: adding the first request and the second request to the machine learning model prompt prior to providing the machine learning model prompt to the one or more machine learning models; and configuring the editorial machine learning model to verify the style, wherein the revised textual summary is consistent with the style and length.

In some aspects, the techniques described herein relate to a method for generating textual content using one or more machine learning models, the method including: receiving, from a client device, a request for a translation of sports related data relating to a sporting event, wherein the sports related data is in machine-readable form; formulating, from the sports related data, a machine learning model prompt, wherein the machine learning model prompt includes (i) instructions readable by the one or more machine learning models and (ii) the sports related data; providing the machine learning model prompt to the one or more machine learning models; receiving, from the one or more machine learning models, textual content corresponding to the sports related data, wherein the textual content is in natural language form; and outputting the textual content to the client device.

In some aspects, the techniques described herein relate to a method, further including: accessing a translation table that translates the sports related data from a first format to a second format; and adding the translation table to the machine learning model prompt prior to providing the machine learning model prompt to the one or more machine learning models.

In some aspects, the techniques described herein relate to a method, wherein the first format is Extensible Markup Language (XML) and the second format is a natural language.

In some aspects, the techniques described herein relate to a method, wherein the translation table maps one or more fields relating to sporting events from the first format to the second format.

In some aspects, the techniques described herein relate to a method, further including receiving, from a live feed, the sports related data, wherein outputting the textual content is performed in real-time.

In some aspects, the techniques described herein relate to a method, wherein the sports related data includes tracking data that is generated based on a broadcast feed of the sporting event, the tracking data including mathematical representations of one or more of positional information, object information, body pose information, or trend information.

In some aspects, the techniques described herein relate to a system including: a non-transitory computer readable medium configured to store processor-readable instructions; and a processor operatively connected to the non-transitory computer readable medium, and configured to execute the processor-readable instructions to perform operations including: receiving, from a client device, a request for a summary of one or more sporting events; accessing, from a database, one or more database records including sports related data that is associated with the one or more sporting events; formulating, from the one or more database records, a machine learning model prompt, wherein the machine learning model prompt includes (i) instructions readable by one or more machine learning models and (ii) sports related data from the one or more database records; providing the machine learning model prompt to the one or more machine learning models; receiving, from the one or more machine learning models, a textual summary of the one or more sporting events; and outputting the textual summary to the client device.

In some aspects, the techniques described herein relate to a system, wherein the processor is configured to execute the processor-readable instructions to perform additional operations including: providing, to an additional machine learning model, a model text having a style; and receiving, from the additional machine learning model, a style summary representing the style of the model text; and providing the style summary to the machine learning model prompt prior to providing the machine learning model prompt to the one or more machine learning models.

In some aspects, the techniques described herein relate to a system, wherein the processor is configured to execute the processor-readable instructions to perform additional operations including providing the textual summary to an editorial machine learning model that is trained to verify factual accuracy of text, identify one or more factual inaccuracies in the textual summary, and correct the one or more factual inaccuracies.

In some aspects, the techniques described herein relate to a system, wherein the request includes preferences for one or more of a length or format of the summary, wherein the processor is configured to execute the processor-readable instructions to perform additional operations including adding the preferences to the machine learning model prompt prior to providing the machine learning model prompt to the one or more machine learning models.

In some aspects, the techniques described herein relate to a system, wherein the sports related data includes tracking data that is generated based on a broadcast feed of the one or more sporting events, wherein the tracking data includes mathematical representations of one or more of positional information, object information, body pose information, or trend information.

In some aspects, the techniques described herein relate to a system, wherein the processor is configured to execute the processor-readable instructions to perform additional operations including: identifying, in the database, one or more preferences associated with a user of the client device; and adding the preferences to the machine learning model prompt prior to providing the machine learning model prompt to the one or more machine learning models.

In some aspects, the techniques described herein relate to a system, wherein the request includes preferences for including a first request for a style and a second request for a length, and wherein the processor is configured to execute the processor-readable instructions to perform additional operations including: adding the first request and the second request to the machine learning model prompt prior to providing the machine learning model prompt to the one or more machine learning models; and configuring an editorial machine learning model to verify that the textual summary is consistent with the style.

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed aspects.

FIG. 1 is a block diagram of an exemplary tracking and analytics environment, in accordance with an aspect of the disclosed subject matter.

FIG. 2 is a block diagram illustrating a textual summary prediction environment, in accordance with an aspect of the disclosed subject matter.

FIG. 3 is a flow diagram of an exemplary method for using machine learning models to generate textual content relating to sporting events, in accordance with an aspect of the disclosed subject matter.

FIG. 4 depicts exemplary data used to generate textual summaries using machine learning models, in accordance with an aspect.

FIG. 5 depicts exemplary textual summaries created using machine learning models, in accordance with an aspect.

FIG. 6 depicts additional exemplary textual summaries created using machine learning models, in accordance with an aspect.

FIG. 7 is a flow diagram of an exemplary method for using machine learning models to translate textual content relating to sporting events, in accordance with an aspect of the disclosed subject matter.

FIG. 8 depicts an exemplary user interface for translating textual content using machine learning models, in accordance with an aspect.

FIG. 9 depicts an exemplary user interface for translating textual content using machine learning models, in accordance with an aspect.

FIG. 10 depicts a flow diagram for training a machine learning model, in accordance with an aspect.

FIG. 11 depicts an example of a computing device, in accordance with an aspect.

Notably, for simplicity and clarity of illustration, certain aspects of the figures depict the general configuration of the various embodiments. Descriptions and details of well-known features and techniques may be omitted to avoid unnecessarily obscuring other features. Elements in the figures are not necessarily drawn to scale; the dimensions of some features may be exaggerated relative to other elements to improve understanding of the example embodiments.

### DETAILED DESCRIPTION OF ASPECTS

Various aspects of the present disclosure relate generally to techniques for machine learning for sports applications. For instance, certain aspects generate textual content relating to sporting events using machine learning models. An event can refer to a particular play such as a pass or a goal, but can also refer to an entire match. As discussed, existing solutions are unable to generate accurate and timely summaries of supporting events. For instance, some existing solutions are unable to the ensure accuracy of generated summaries. Disclosed solutions address these shortcomings.

The following non-limiting example is introduced for discussion purposes. A machine-learning environment receives, from a client device, a request to generate a summary of a sporting event. The environment obtains relevant data and generates a prompt, which may include a desired style and length, which is provided to one or more machine learning models. In turn, the one or more models generate and output a summary of the sporting event. In some cases, additional machine learning models verify and/or adjust style, tone, grammar, spelling, and/or factual accuracy as appropriate. The generated summary is then provided to the client device.

The following additional example is introduced for discussion purposes. A machine-learning environment receives, from a client device, a request to translate sports-related data, for example, from machine readable form to human readable (natural language) form. The sports-related data can relate to one or more sporting events. The environment generates a prompt that includes the sports-related data and any preferences such as style, language or perspective. The prompt is provided to one or more machine learning models. In turn, the one or more models output a translation of the data. The translation can be further editorialized or stylized as appropriate by additional machine learning models. The resulting textual content is then provided to the client device.

Technical advantages of the disclosed techniques include improvements to machine learning. For instance, certain aspects provide improved data preparation and machine learning prompt generation, which results in an improved performance and accuracy of machine learning models. Other aspects provide improved editorial functions by leveraging specially-trained machine learning models, as compared to using a single model for both textual generation and editorial functions.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as generative learning, linear regression, logistic regression, random forest, gradient boosted machine (GBM), deep learning, graph neural networks (GNN) and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, disclosed techniques may be adapted to any suitable type of machine learning. It should also be understood that the examples above are illustrative only. The techniques and technologies of this disclosure may be adapted to any suitable activity.

While soccer and various aspects relating to soccer (e.g., a predicted total number of passes by a team during a game) are described in the present aspects as illustrative examples, the present aspects are not limited to such examples. For example, the present aspects can be implemented for other sports or activities, such as American football, basketball, baseball, tennis, golf, rugby, hockey, team sports, individual sports, and so forth.

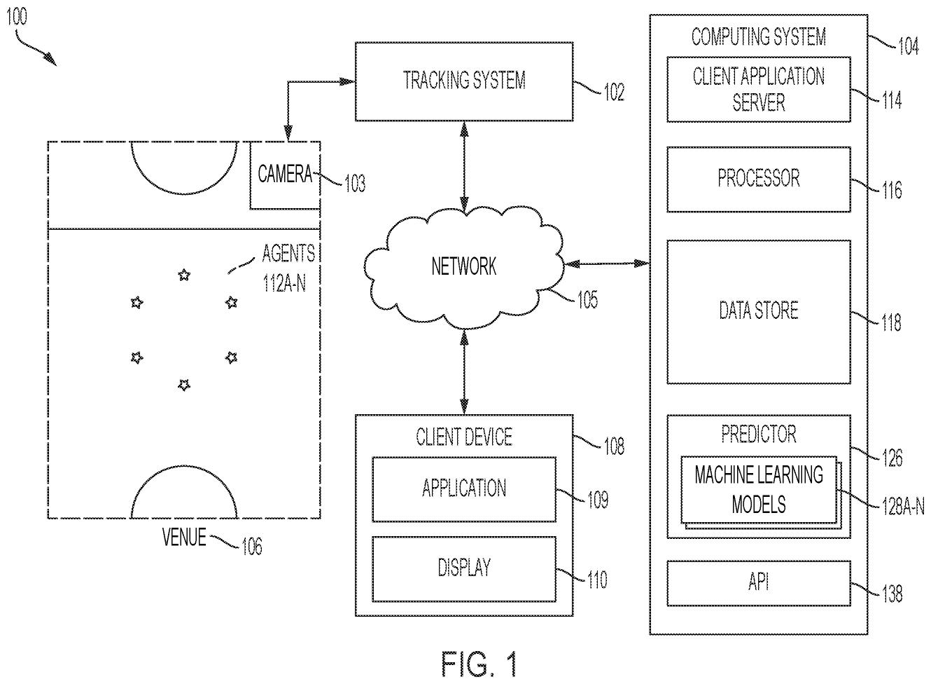

FIG. 1 is a block diagram illustrating a tracking and analytics environment 100, in accordance with an aspect of the disclosed subject matter. Environment 100 includes tracking system 102, computing system 104, and client device 108 connected via network 105. In the example depicted, tracking system 102 obtains various measurements of game play, and transmits the measurements across network 105 to computing system 104, where one or more machine learning models are used to generate textual data relating to one or more sporting events, such as a play, a pass, a goal, or an entire match.

Tracking system 102 is be positioned in, adjacent to, or near a venue 106. Non-limiting examples of venue 106 include stadiums, fields, pitches, and courts. Venue 106 includes agents 112A-N (players). Tracking system 102 may be configured to record the motions and actions of agents 112A-N on the playing surface, as well as one or more other objects of relevance (e.g., ball, referees, etc.). Although environment 100 depicts agents 112A-N generally as players, it will be understood that in accordance with certain implementations, agents 112A-N may correspond to players, objects, markers, referees, and/or the like.

In some aspects, tracking system 102 may be an optically-based system using, for example, using camera 103. While one camera is depicted, additional cameras are possible. For example, a system of six stationary, calibrated cameras, which project the three-dimensional locations of players and the ball onto a two-dimensional overhead view of the court may be used.

In some aspects, a mix of stationary and non-stationary cameras may be used to capture motions of all agents 112A-N on the playing surface as well as one or more objects or relevance. Utilization of such tracking system (e.g., tracking system 102) may result in many different camera views of the court (e.g., high sideline view, free-throw line view, huddle view, face-off view, end zone view, etc.). In some aspects, tracking system 102 may be used for a broadcast feed of a given match. In such aspects, each frame of the broadcast feed may be stored in a game file. In some aspects, the game file may further be augmented with other event information corresponding to event data, such as, but not limited to, game event information (pass, made shot, turnover, etc.) and context information (current score, time remaining, etc.).

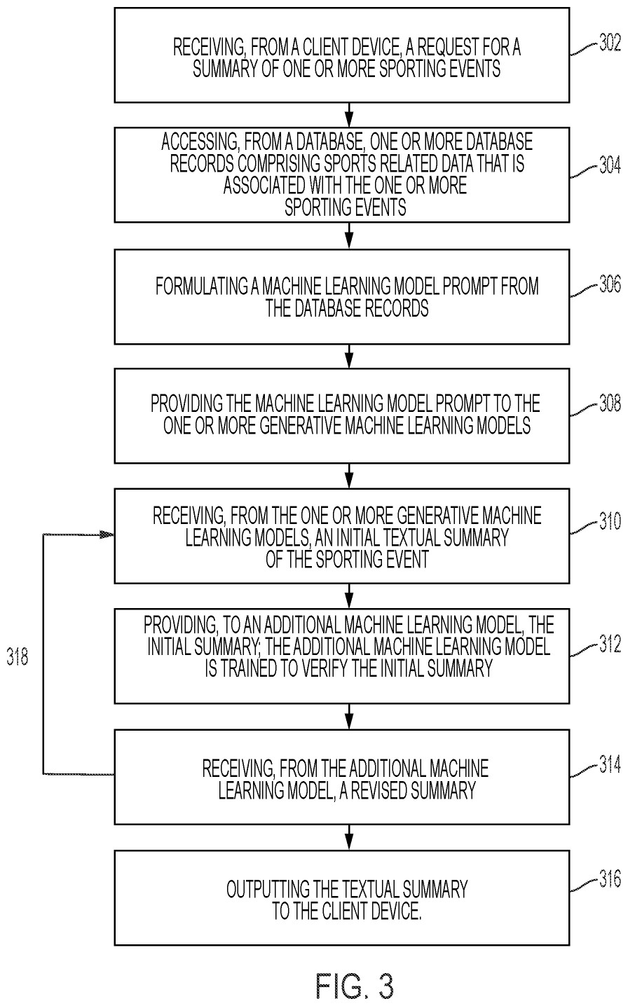

In some aspects, a game file may include ratings data, standings data, statistics, and/or odds, as discussed further with respect to FIG. 3. In some aspects, a game file may include one or more match data types. Match data type may include, but is not limited to, position data (e.g., player position, object position, etc.) change data (e.g., changes in position, changes in players, changes in objects, etc.), trend data (e.g., player trends, position trends, object trends, team trends, etc.), play data, etc. A game file may be a single game file or may be segmented (e.g., grouped by one or more data type, grouped by one or more players, grouped by one or more teams, etc.).

Processor 116 and/or data store 118 may be operated (e.g., using applicable code) to receive tracking data in a first format, store game files in a second format, and/or output game data (e.g., to predictor 126) in a third format. For example, processor 116 may receive an intended destination for game data (or data stored in data store 118 in general) and may format the data into a format acceptable by the intended destination.

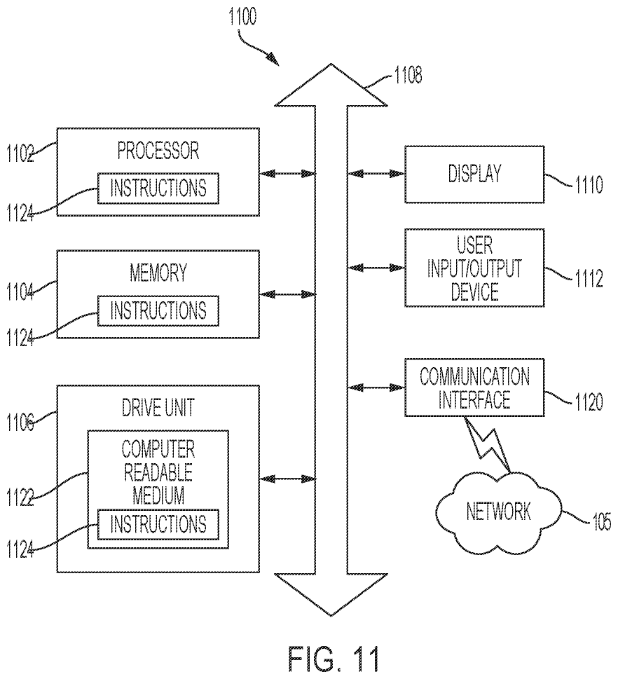

Computing system 104 may be configured to manage and analyze the data captured by tracking system 102 and/or additional data such as game data from previous games and environmental data. Examples of environmental data include venue data, referee data, and weather data. Computing system 104 may include a web client application server 114, a processor 116 (e.g., a preprocessor agent), a data store 118, predictor 126, and a third-party Application Programming Interface (API) 138. An example of computing system 104 is depicted with respect to FIG. 11. Processor 116 may be configured to process data retrieved from data store 118 or tracking system 102 prior to input to predictor 126.

Data store 118 may be configured to store different kinds of data. In an example, data store 118 can store raw tracking data received from tracking system 102. The data store 118 can include historical game data, which can include historical team and player data for one or more sporting events. Data store 118 may be configured to store one or more game files. Each game file may include video data of a given match (e.g., a game, a competition, a round, etc.) and/or may include tracking data generated by tracking system 102 or in response to data generated by tracking system 102. Video data may correspond to data for an ongoing match or data for a previous or historical match. For example, the video data may correspond to video frames captured by tracking system 102. In some aspects, the video data may correspond to broadcast data of a given match, in which case, the video data may correspond to video frames of the broadcast feed of a given match.

Predictor 126 can include one or more machine learning models 128A-N. Predictor 126 may be configured to train or retrain machine learning models 128A-N. In some cases, one or more of the machine learning models 128A-N are remotely hosted, for example on a remote server. Machine learning models 128A-N can be generative machine learning models, large language models, and/or any other suitable types of machine learning models.

In some cases, the machine learning models 128A-N require input of a prompt. As such, computing system 104 and/or predictor 126 can generate one or more prompts such that the output of the model is more appropriate. A prompt can include instructions to the model (e.g., task(s) to be performed, and style of output), data to be used (e.g., data from a particular team or a player), and/or any user preferences (e.g., style, tone, or length).

Any component of computing system 104, for example as processor 116 or predictor 126, may include or may be implemented using one or more software modules. The software modules may be collections of code or instructions stored on a non-transitory computer-readable medium (e.g., memory of computing system 104) that represent a series of machine instructions (e.g., program code) that implements one or more algorithmic operations. Such machine instructions may be the actual computer code the processor of computing system 104 interprets to implement the instructions or, alternatively, may be a higher level of coding of the instructions that is interpreted to obtain the actual computer code. In some cases, functionality implemented by the software modules may be implemented via one or more hardware components. One or more aspects of an example algorithm may be performed by the hardware components (e.g., circuitry) itself, rather as a result of the instructions.

Network 105 may be of any suitable type, including individual connections via the Internet, such as cellular or Wi-Fi networks. In some aspects, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some aspects, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Client device 108 may be in communication with computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with computing system 104, such as individuals who have obtained, will obtain, or may obtain a product, service, or consultation from an entity associated with computing system 104.

Client device 108 may include one more applications 109. Application 109 may be representative of a web browser that allows access to a website or a stand-alone application. Client device 108 may access application 109 to access one or more functionalities of computing system 104. Client device 108 may communicate over network 105 to request a webpage, for example, from web client application server 114 of computing system 104. For example, client device 108 may be configured to execute application 109 to access content managed by web client application server 114. The content that is displayed to client device 108 may be transmitted from web client application server 114 to client device 108, and subsequently processed by application 109 for display through a graphical user interface (GUI) of client device 108.

Client device may include display 110. Examples of display 110 include, but are not limited to, computer displays, Light Emitting Diode (LED) displays, and so forth. Output or visualizations generated by application 109 can be displayed on display 110.

As discussed herein, one or more machine learning models may be trained to understand a sports language. Accordingly, machine learning models disclosed herein are sports machine learning models. Such sports machine learning models may be trained using sports related data (e.g., tracking data, event data, etc., as discussed herein). A sports machine learning model trained to understand a sports language based on sports related data may be trained to adjust one or more weights, layers, nodes, biases, and/or synapses based on the sports related data. A sports machine learning model may include components (e.g., a weights, layers, nodes, biases, and/or synapses) that collectively associate one or more of: a player with a team or league; a team with a player or league; a score with a team; a scoring event with a player; a sports event with a player or team; a win with a player or team; a loss with a player or team; and/or the like. A sports machine learning model may correlate sports information and statistics in a competition landscape. A sports machine learning model may be trained to adjust one or more weights, layers, nodes, biases, and/or synapses to associate certain sports statistics in view of a competition landscape. For example, a win indicator for a given team may automatically correlated with a loss indicator for an opposing team. As another example, a score static may be considered a positive attribution for a scoring team and a negative attribution for a team being scored upon. As another example, a given score may be ranked against one or more scores based on a relative position of the score in comparison to the one or more other scores.

A sports machine learning model may be trained based on sports tracking and/or event data, as discussed herein. Such data may include player and/or object position information, movement information, trends, changes. For example, a sports machine learning model may be trained by modifying one or more weights, layers, nodes, biases, and/or synapses to associate given positions in reference to the playing surface of venue 106 and/or in reference to none or more agents 112A-N. As another example, a sports machine learning model may be trained by modifying one or more weights, layers, nodes, biases, and/or synapses to associate given movement or trends in reference to the playing surface of venue 106 and/or in reference to none or more agents 112A-N. As another example, a sports machine learning model may be trained by modifying one or more weights, layers, nodes, biases, and/or synapses to associate sporting events with corresponding time boundaries, teams, players, coaches, officials, and environmental data associated with a location of corresponding sporting events.

A sports machine learning model may be trained by modifying one or more weights, layers, nodes, biases, and/or synapses to associate position, movement, and/or trend information in view of a sports target. A sports target may be a score related target (e.g., a score, a goal, a shot, a shot count, a point, etc.), a play outcome (e.g., a pass, a movement of an object such as a ball, player positions, etc.), a player position, and/or the like. A sports machine learning model may be trained in view sports targets, play outcomes, player positions, and/or the like associated with a given sport (e.g., soccer, American football, basketball, baseball, tennis, golf, rugby, hockey, a team sport, an individual sport, etc.). For example, a soccer based sports machine learning model may be trained to correlate or otherwise associate player position information in reference to a soccer pitch. The soccer based sports machine learning model may further be trained to correlate or otherwise associate sports data in reference to a number of players and sports targets specific to soccer.

According to aspects, one or more given sports machine learning model types (e.g., generative learning, linear regression, logistic regression, random forest, gradient boosted machine (GBM), deep learning, graph neural networks (GNN) and/or a deep neural network) may be determined based on attributes of a given sport for which the one or more machine learning models are applied. The attributes may include, for example, sport type (e.g., individual sport vs. team sport), sport boundaries (e.g., time factors, player number factors, object factors, possession periods (e.g., overlapping or distinct), playing surface type (e.g., restricted, unrestricted, virtual, real, etc.) player positions, etc.

According to aspects, a sports machine learning model may receive inputs including sports data for a given sport and may generate a matrix representation based on features of the given sport. The sports machine learning model may be trained to determine potential features for the given sport. For example, the matrix may include fields and/or sub-fields related to player information, team information, object information, sports boundary information, sporting surface information, etc. Attributes related to each field or sub-field may be populated within the matrix, based on received or extracted data. The sports machine learning model may perform operations based on the generated matrix. The features may be updated based on input data or updated training data based on, for example, sports data associated with features that the model is not previously trained to associate with the given sport. Accordingly, sports machine learning models may be iteratively trained based on sports data or simulated data.

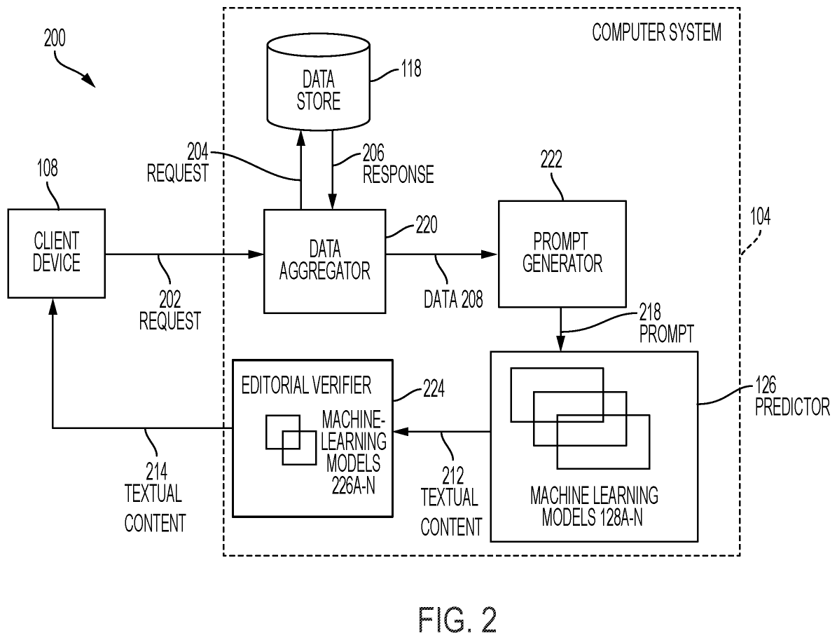

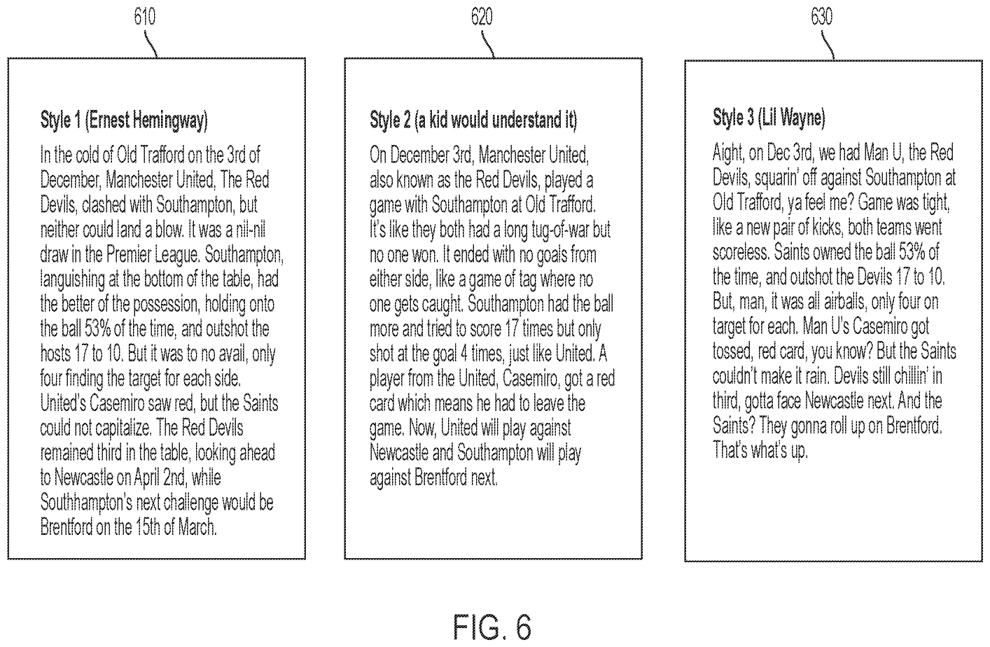

FIG. 2 is a block diagram illustrating a textual prediction environment 200, in accordance with an aspect of the disclosed subject matter. In the example depicted, textual prediction environment 200 generates textual output related to sporting events. For instance, textual prediction environment 200 can generate summaries of one or more events, as further detailed with respect to FIGS. 3-6. Textual prediction environment 200 can also translate sports-related data from machine-readable form to natural language form, as further detailed with respect to FIGS. 6-9.

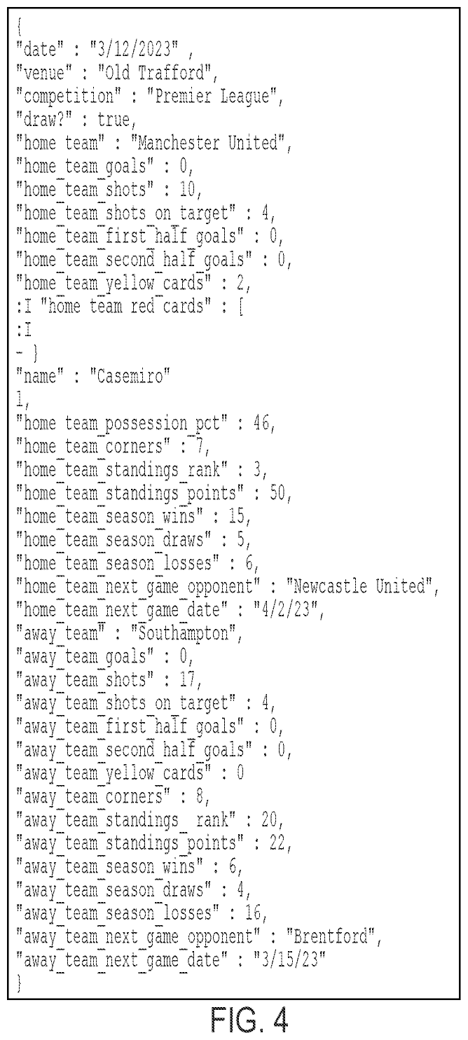

Computing system 104 includes data store 118, data aggregator 220, prompt generator 222, editorial verifier 224, and predictor 126. Data store 118 can store one or more kinds of data in database records, linked lists, arrays, or other data structures. Examples of data include player tracking data as captured by tracking system 102, player ratings, excitement ratings and/or headlines, injury data, and/or environmental data. Various types of data are further discussed with respect to FIG. 4.

In some cases, data store 118 can be updated with new data (e.g., live data or updated ratings) and/or requestor preferences, as appropriate. In some cases, a request to the data store 118 can be in the form of a Hypertext Transfer Protocol (HTTP) command such as a “GET” command, “POST” command, or similar. In some cases, the response from data store 118 can be a Javascript Object Notation (JSON) response or an Extensible Markup Language (XML) file.

Data aggregator 220 may receive request 202 from client device 108. A request from client device 108 can include various parameters such as a type of request (e.g., summary, translation, etc.), appropriate data such as teams, sports, leagues, players of interest, and/or any stylistic preferences. For example, a request 202 may include specified tone of a casual type and a length of 100 words. In another example, client device 108 transmits a request 202 that includes a request for a human-readable translation of a particular set of sports data.

Upon receipt of request 202, data aggregator 220 can process request 202 and generate a request 204 to obtain data from data store 118. Request 204 can be formulated or adjusted based on preferences obtained via request 202, e.g., from client device 108.

Accordingly, the type of data requested in request 204 can depend on the contents of request 202. For instance, request 204 can include specific attributes such as sports, team names, leagues, players, and so forth. In some cases, one or more Application Programming Interfaces (APIs) 138 can be used to obtain the data from the data store 118.

Data aggregator 220 can obtain relevant data from data store 118 and/or from client device 108. Continuing the example, relevant data in this case may include a performance of each team throughout the season, performance of particular players, odds, and so forth. In some cases, data aggregator 220 can further refine or filter the data obtained from data store 118. For instance, data store 118 may provide data that is not relevant, or may provide more data than can be provided to a machine learning model given various constraints such as bandwidth or processing time. In these cases, the obtained data may be filtered. In some cases, data aggregator 220 can process the received data and issue an additional request to data store 118 for additional data. Data aggregator 220 can pass the data 208, to prompt generator 222. In some cases, the data may be user-specified by client device 108. In such cases, a query to data store 118 may not be necessary.

In turn, prompt generator 222 can formulate a prompt 218 designed to obtain an accurate and appropriate summary or translation from predictor 126 (including machine learning models 128A-N). As discussed further herein, prompt 218 can include information such as instructions readable by one or more of machine learning models 128A-N, data derived from various database records obtained from data store 118 by data aggregator 220 and/or specified by client device 108, and preferences received from client device 108 via request 202.

Prompt generator 222 provides prompt 218 to predictor 126, which in turn passes prompt 218 to one or more of the machine learning models 128A-N. The machine learning models 128A-N output textual content 212. In some cases, multiple machine learning models 128A-N are used. In some cases, machine learning models 128A-N are used in an iterative manner, that is, results can be obtained and then provided back into one or more of machine learning models 128A-N for further analysis or refinement.

Machine learning models 128A-N may be trained to output the textual content 212 using training data that includes historical or simulated prompts, sports data, formatting information, textual summaries, translations, and/or the like. The training data may be tagged or untagged. Accordingly, machine learning models 128A-N may be trained using sports specific training data. As such, in comparison to general machine learning models, machine learning models 128A-N may be trained to output text content 212 based on a sports language that is otherwise not understandable by general machine learning models. More specifically, machine learning models 128A-N may be trained using sports tracking and/or event data. Sports tracking data may include trained sports information that includes player and/or object position information, movement information, trends, changes, and/or the like. Sports event data may be annotated or tagged data that is annotated or tagged by a user or via a system. Such event data may include information such as an action (e.g., a pass, a goal, a type of sports activity, etc.), an event (e.g., a time based event such as the beginning or end of a quarter or half, possession time, etc.).

In some aspects, textual content 212 obtained from predictor 126 can be formatted. Formatting requirements can include, but is not limited to, stylistic formatting, style, spelling, and grammar. Machine learning models 128A-N may include a generative machine learning model trained using training data that includes such stylistic formatting, style, spelling, and grammar. For example, the training data may include examples of a plurality of formats, styles, spelling, and grammar (e.g., text experts, reference text, sports articles, etc.) which may be tagged. According to this example, a first machine learning model may output the substance associated with textual content 21. The substance may be used as an input to a generative machine learning model to output textual content 212, based on the formatting requirements. Accordingly, textual content 212 may be based on the substance output by the first machine learning model and the format requirements applied by the generative machine learning model.

In some aspects, textual content 212 from predictor 126 can be edited for content. For instance, editorial verifier 224 may verify, correct, and/or revise generated text prior to the text being provided to client device 108. For example, generated summaries can be verified for style, tone, grammar, spelling, and/or factual accuracy. Editorial verifier 224 can include one or more machine learning models 226A-N.

Each machine learning model 226A-N can be trained for one or more specific purposes. For instance, machine learning model 226A can be trained to verify a style, whereas machine learning model 226B can be trained to verify factual accuracy. In some cases, specialized purpose models can yield improved results relative to models that are trained for multiple purposes. Leveraging machine learning models 226A-N can therefore improve results relative to systems lacking an editorial function. In some cases, machine learning models 128A-N can be used instead of machine learning models 226A-N.

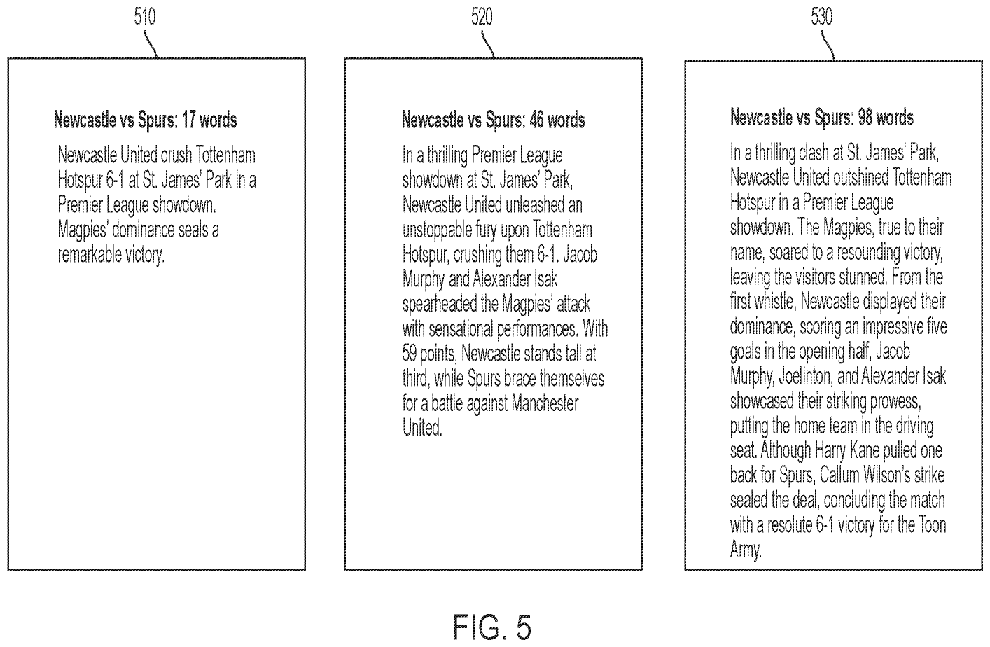

Following any editorial verification, a summary is provided to client device 108. Examples of summaries are provided with respect to FIGS. 5 and 6. But summaries with other styles, formats, and so forth are possible.

FIG. 3 is a flow diagram of an exemplary method 300 for using machine learning models to generate textual content relating to sporting events, in accordance with an aspect of the disclosed subject matter. For illustrative purposes, method 300 is discussed with respect to environment 100 of FIG. 1 and environment 200 of FIG. 2.

Method 300 includes various operations, indicated by blocks. It will be appreciated that in some cases, not all operations are performed. For example, in some cases, some operations can be skipped. In some examples, operations can be performed multiple times, for example, in a loop. Other variations are possible.

Method 300 can be used to create generate textual summaries of sporting events. In some cases, user preferences are accommodated when generating the textual summaries. In some cases, these preferences can be aggregated into one or more profiles. For instance, a particular user may prefer short summaries, a particular sentiment, or a bias (e.g., a preference for information about their favorite team only). Accordingly, in some cases, method 300 operates in the context of a set of predefined user preferences.

At block 302, method 300 may involve receiving, from a client device, a request for a summary of a sporting event. For example, client device 108 sends a request 202 for a summary of a sporting event to computing system 104. In turn, computing system 104, specifically, data aggregator 220, receives request 202.

Request 202 can include one or more specific details. For instance, request 202 can include the relevant sport (e.g., soccer), a league, team names, and so forth. In some cases, request 202 can include a specific game or match. In some cases, request 202 can include one or more preferences. For example, request 202 can include a request for a specific style such as “in the style of Jane Austin” or “in the style of Jeremy Clarkston.” Preferences can further include a length of the summary, which can be specified in characters, words, and/or pages. Examples of length include “45 words” and “100 words.” Preferences can further include an output language such as “English” or “Spanish.”

At block 304, method 300 may involve accessing, from a database, one or more database records including sports related data that is associated with the sporting event. Continuing the example, data aggregator 220 formulates request 204 and provides request 204 to data store 118. The request 204 may be based on request 202 such that specific sports related attributes are determined based on request 202 to formulate request 204. Accordingly, data aggregator 220 may analyze request 202 to determine relevant sports related attributes. Such attributes may include, but are not limited to, team information, coach information, official information, injury information, player information, sports statistics, time period associated with request 202, trend information, etc. In an example, the data requested includes ratings of players on a team associated with the sporting event, standing of the team relative to an associated league, and odds of a predicted performance of the team.

In some aspects, relevant data may be provided by the user in the form of a file or a reference. In this case, data aggregator 220 may not need to access additional data or may access additional data to supplement data provided by the user in accordance with the techniques disclosed herein. Example data formats include an XML and JSON.

The data requested can differ based on the type of summary requested, specifically game previews, summaries, and live reports. For example, in the case of a live report, the requested data can be live data. The live data can include tracking data generated based on a broadcast feed or in-venue feed of the sporting event or based on live cameras at the sporting event. The tracking data can include mathematical representations of positional information, object information, body pose information, or trend information. The data requested can include environmental data. Examples of environmental data include venue data, referee data, weather data, and so forth.

In some cases, the data format may not be compatible with a format accepted by the machine learning models 128A-N. Accordingly, in some cases, the sports related data is modified from a first format (e.g., native to the data store 118) to a second format (e.g., native to the machine learning models 128A-N). Data aggregator 220 may determine a format accepted by applicable machine learning models 128A-N and may cause data received in the first format to a second format accepted by the applicable machine learning models 128A-N. Continuing the example, data aggregator 220 provides the received data from response 206 to prompt generator 222 as data 208.

At block 306, method 300 may involve formulating from the database records, a machine learning model prompt. The prompt can include one or more of instructions, data, and preferences received from client device 108 and/or retrieved from a preference file.

As discussed, instructions can relate to task, topic, style, tone, or format of the desired textual output. Such preferences, which can be received from client device 108 via request 202, are added to the prompt prior to providing the prompt to the one or more generative machine learning models. As discussed with respect to block 304, data can be obtained from data store 118 and optionally filtered for relevancy. Examples of possible instructions include a task, topic, style, tone, audience, length.

In some cases, the prompt includes a style. Examples of styles include casual, formal, business, etc. In some cases, the styles can include personality names such as Jane Austen or Jeremy Clarkston. In some cases, the prompt includes a tone. Examples of tones are happy, sad, optimistic, and ecstatic. In some cases, the prompt includes a specified output format. Examples are text, HTML, XML, and so forth. In some cases, the prompt can include a requested language such as English or Spanish.

In some aspects, a desired style is received from client device 108. The style can be known, e.g., already modeled, or new. If the style is new, then the style can first be learned by machine-learning models 128A-N. For instance, predictor 126 can provide a text being written in the desired style to one or more of machine-learning models 128A-N (e.g., a generative machine learning model). Predictor 126 can then receive, from machine-learning models 128A-N, a style summary representing the style of the model text. Once modeled, the style summary can be provided to one or more of machine-learning models 128A-N, via a prompt, as further explained with respect block 308.

According to an aspect, prompts can be provided in natural language format. For example, in the context of textual summaries, therefore, a simplified example of a prompt might include “summarize the current match between Arsenal and Liverpool” or “summarize the current match using only the included data.”

Continuing the example, prompt generator 222 generates a prompt 218. The machine learning model prompt can include instructions readable by machine learning models 128A-Nand/or sports related data from the one or more database records.

At block 308, method 300 may involve providing the machine learning model prompt to the one or more generative machine learning models. Continuing the example, prompt generator 222 provides prompt 218 to predictor 126, including one or more of machine learning models 128A-N. As discussed, machine learning models 128A-N can be generative machine learning models.

At block 310, method 300 may involve receiving, from the one or more generative machine learning models, an initial textual summary of the sporting event. Continuing the example, in turn, editorial verifier 224 receives, from the machine learning models 128A-N, textual content 214.

The textual content 214 may be edited, formatted, or otherwise updated or altered before being output as textual content 214. As discussed, improved editorial performance can be achieved by using specifically-trained machine learning models, each dedicated to a particular editorial function.

For example, at block 312, method 300 involves providing, to an additional machine learning model, the initial textual summary. Editorial verifier 224 includes one or more machine learning models 226A-N. Each machine learning model 226A-N can be trained to perform one or more tasks related to editorial verification.

For example, a first machine learning model 226A can be trained to verify a factual accuracy of the initial summary. In some cases, the machine learning model may identify corrections to be made, and in other cases, the model may make the corrections automatically. A second machine learning model 226B can be trained to verify and correct style, and so forth. In some cases, multiple additional machine learning models are used, for example, each model for different purposes.

In some aspects, machine learning prompts are used at block 312. For instance, a prompt can provide detailed instructions to a particular machine-learning model such as a type of editorial function to be performed, computational constraints, or other instructions. Examples of prompts include “is this correct” and “are you sure that this is correct.”

At block 314, method 300 involves receiving, from the additional machine learning model, a revised summary. If multiple additional machine learning models 226A-N are used, for instance, for different editorial functions, or to perform additional revisions, then one or more of blocks 310-314 may be repeated as necessary with different machine learning models, as illustrated by 318.

At block 316, method 300 may involve outputting the textual summary to the client device. Continuing the example, the textual content 214 is provided to client device 108.

FIG. 4 depicts exemplary data 400 used to generate textual summaries using machine learning models, in accordance with an aspect. As depicted, data 400 includes various statistics and facts relating to a particular game, including date, venue, competition, outcome, team names, and other statistics. As depicted, data 400 is represented in XML format. But other formats are possible.

Data 400 can include any sports-related data. Examples include ratings data, standings data, team statistics, and odds. Further, data can be updated in real-time, for example, including updates on a game in play, updated league tables, or rankings.

Example ratings data includes player ratings, team ratings, excitement rating, and/or other ratings. Ratings can include multiple entries for various games such as scores, passes, and assists. But other entries are possible such as Shots, Goals (xG), Assists (xA), Crosses, Total Passes, Total Short Passes (<32 m), Total Long Passes (^{˜}32 m), Passes in Attacking Thirds, Penalty Area Entries, Take-downs, Defensive Actions in Own Third, Defensive Actions in Middle Third, Defensive Actions in Opposition Thirds, and so forth. While these examples are specific to soccer, it will be appreciated, that other ratings are possible for other sports. For example, in the context of baseball, relevant ratings may include batting statistics and pitching statistics. Examples of batting statistics include slugging (total number of bases reached by a hitter divided by the number of at-bats); on-base plus slugging (OPS), which refers to how often a batter gets on base and how often they get other bases. Examples of pitching statistics include innings pitched, hits, runs, and so forth.

In some cases, ratings data can also include excitement ratings. Non-limiting examples of excitement ratings include a measurement of interest in a particular game, player, or league and a measurement of interest in games or matches that are at particular times of day or night, at a particular point in a season, and so forth. Excitement ratings can be neutral, that is, not from a perspective of a fan of one team or another, but from a neutral observer or a non-fan. In some cases, excitement ratings can be from the perspective of a fan of a particular team. In some cases, the excitement ratings can be affected by whether a game is played at home or away.

In some cases, ratings data can include headline data. Headline data can include whether a player or team has made it into headlines of a print or online publication. In some cases, the headline data can be used in or referred to by the textual output. In some cases, ratings data can include injury data. Examples of injury data include injuries sustained by a current player, a current status of an injury, predicted injuries, whether an injured player is healing, how long the player may be out of commission, and so forth. For live reports, injury data can be updated in real time, for instance, if a player gets injured, then ratings can include real updates about the injury.

Data 400 can include standings data. Standings data can include data indicating relative standings of teams within a particular league. For example, a team could be ranked second out of forty teams. For instance, in the context of premier league soccer, the premier league standings table may be used. This table ranks each team and includes games won, drawn, lost, home and away statistics, and so forth.

Data 400 can include statistics relating to a particular team. For examine, in the context of soccer, statistics could include wins, number of losses, and so forth for a particular team, etc. In baseball, statistics may include home runs, strikes, and so forth. Statistics can be aggregated player statistics, and/or linked to statistics of particular players.

Data 400 can include odds data. Odds data can include betting odds different teams within a league or different matchups of teams, whether hypothetical or real. Odds can be based on predicted or actual performance of teams.

FIG. 5 depicts exemplary textual summaries created using machine learning models, in accordance with an aspect. FIG. 5 depicts textual summaries 510, 520, and 530, which each describe a soccer match between Newcastle United and Tottenam Hotspur.

Each of textual summaries 510, 520, and 530 were generated with different length constraints. For example, textual summary 510 is 17 words long, textual summary 520 is 46 words long, and textual summary 530 98 words long. As depicted, longer summaries provide for more detail.

FIG. 6 depicts additional exemplary textual summaries created using machine learning models, in accordance with an aspect. FIG. 6 depicts textual summaries 610, 620, and 630, which each describe a soccer match between Manchester United and Southampton.

Each of textual summaries 610, 620, and 630 were generated with different style constraints. As depicted, textual summary 610 is in the style of Earnest Hemmingway, textual summary 620 in the style that is understandable by a child, and textual summary 620 in the style of the rapper Lil Wayne.

As discussed, certain aspects can identify and/or correct various mistakes in text output from machine learning models. For example, referring back to textual summary 610, the summary states “in the cold of Old Trafford.” Certain editorial models can identify whether this statement relates to an expression that one would expect Earnest Hemmingway to say, or whether in fact the weather was cold that day.

Various aspects can also identify and/or correct mistakes resulting from machine learning models guessing and/or hallucinating. For instance, if a textual summary identifies that a player was issued a red card in the second half of a game, then the editorial models can verify the timing of the red card to ensure that the textual summary is factually accurate.

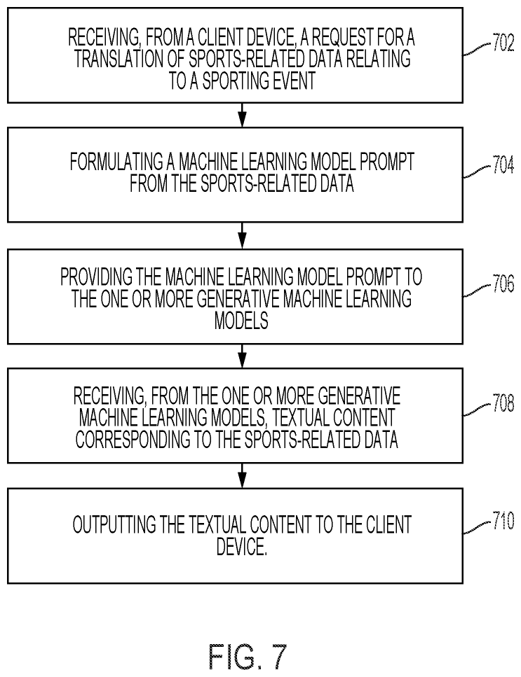

In an aspect, disclosed techniques relate to translating machine-readable data files that include sports related data into human-readable form. Sports analytics can involve storing data files, for example as depicted in FIG. 4. But these files are not easily readable by a human. As such, disclosed techniques can translate these files into human readable form. The resulting textual information includes facts and statistics related to one or more sporting events. FIG. 7 describes an example method.

FIG. 7 is a flow diagram of an exemplary method 700 for using machine learning models to translate textual content relating to sporting events, in accordance with an aspect of the disclosed subject matter. For illustrative purposes, method 700 is discussed with respect to environment 100 of FIG. 1 and environment 200 of FIG. 2.

Method 700 includes various operations, indicated by blocks. It will be appreciated that in some cases, not all operations are performed. For example, in some cases, some operations can be skipped. In some examples, operations can be performed multiple times, for example, in a loop. Other variations are possible.

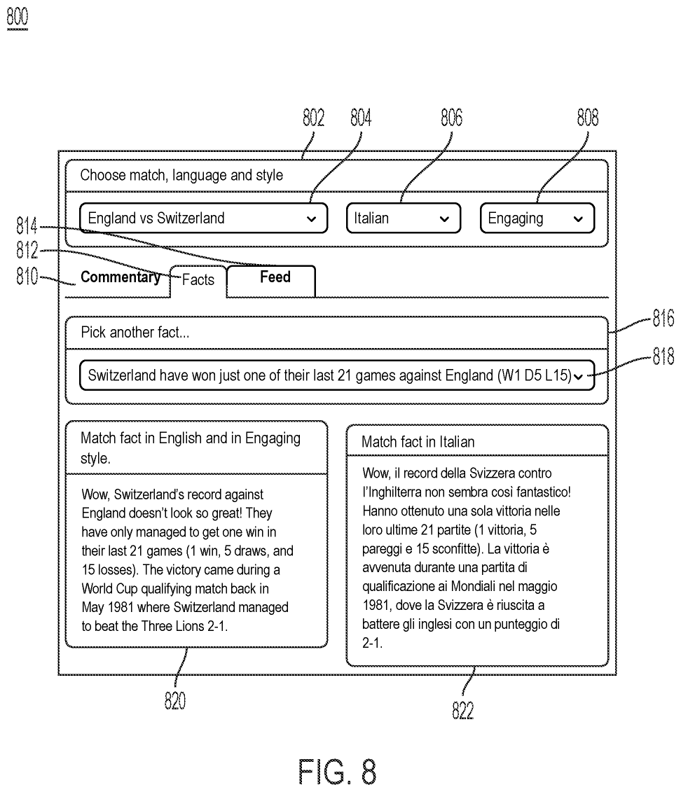

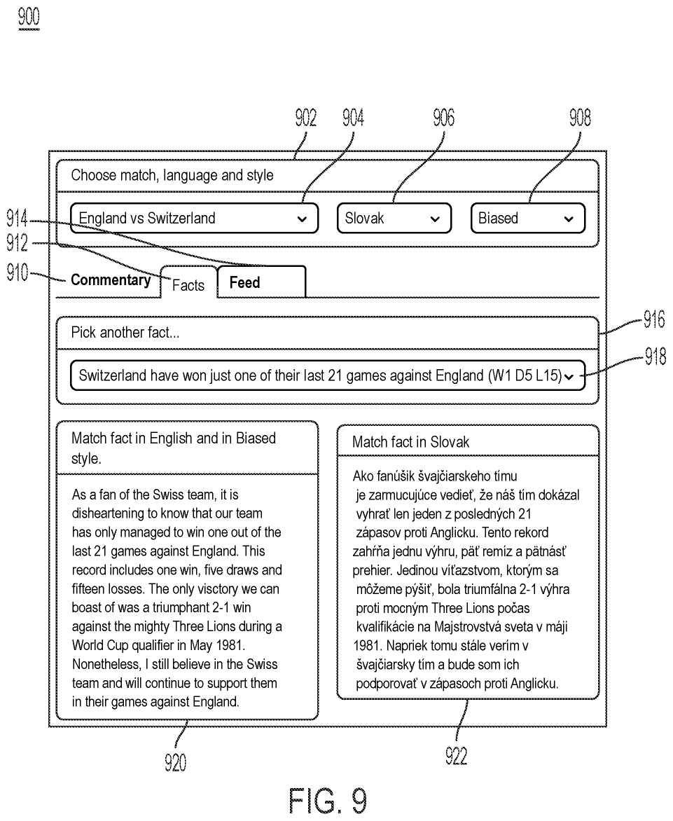

At block 702, method 700 can involve receiving, from a client device, a request for a translation of sports related data relating to a sporting event. The sports related data is in machine-readable form. At block 702, method 700 can involve similar operations as discussed with respect to block 302 of method 300. In some cases, the sports-related data is received from a live feed, enabling the resulting translation to be provided in real-time or near real-time. In some cases, the request can be received via a user interface, for example, as discussed with respect to FIGS. 8 and 9.

In some aspects, a translation table is used. The translation table includes entries that map the sports related data from a first format (e.g., machine-readable XML) to a second format (e.g., natural language). The table can be provided to one or more machine learning models by way of a prompt, as discussed further with respect to block 704.

At block 704, method 700 can involve formulating, from the sports related data, a machine learning model prompt. The machine learning model prompt can include instructions readable by the one or more machine learning models and the sports related data.

At block 704, method 700 can involve similar operations as discussed with respect to block 306 of method 300.

At block 706, method 700 can involve providing the machine learning model prompt to the one or more generative machine learning models. The prompt can include one or more of instructions, data, and preferences received from client device 108 and/or retrieved from a preference file.

At block 708, method 700 can involve receiving, from the one or more generative machine learning models, textual content corresponding to the sports related data. The textual content is in natural language form.

Machine learning models 128A-N output textual content 214. The textual content 214 may be edited, formatted, or otherwise updated or altered before being output as textual content 214. In some aspects, the output contains bare facts such as “Messi scored a goal at minute 5 of the game.” In other cases, the facts are editorialized. Editorial functions can be performed as described with respect to blocks 312 and 314.

At block 710, method 700 can involve outputting the textual content to the client device. At block 710, method 700 can involve similar operations as discussed with respect to block 316 of method 300. Exemplary outputs are further illustrated with respect to FIGS. 8 and 9 and accompanying text.

FIG. 8 depicts an exemplary user interface 800 for translating textual content using machine learning models, in accordance with an aspect. User interface 800 includes instructions 802, match selector 804, output language selector 806, style selector 808, commentary tab 810, facts tab 812, feed tab 814, instructions 816, fact selector 818, and output panes 820 and 822.

User interface 800 can be displayed on client device 108. Instructions 802 inform the user to “Choose match, language and style.” A user of client device 108 can choose a match from match selector 804, an output language from language selector 806, and a style from style selector 808. As depicted, a user selects “England vs Switzerland” as the match, Italian as the output language, and “Engaging” as the style.

One of commentary tab 810, facts tab 812, and feed tab 814 can be selected. As depicted, facts tab 812 is selected. Instructions 816 instruct the user to “Pick another fact . . . ” The user selects a fact from fact selector 818, which is optionally previewed in the selector. Then, the system creates output in output panes 820 and 822. As can be seen, the output in output pane 820 is written in an engaging style in English, and the output in output pane 822 is written in an engaging style in Italian.

FIG. 9 depicts an exemplary user interface 900 for translating textual content using machine learning models, in accordance with an aspect. User interface 900 includes instructions 902, match selector 904, output language selector 906, style selector 808, commentary tab 910, facts tab 912, feed tab 914, instructions 916, fact selector 918, and output panes 920 and 922.

User interface 900 can be displayed on client device 108. Instructions 902 inform the user to “Choose match, language and style.” A user of client device 108 can choose a match from match selector 904, an output language from language selector 906, and a style from style selector 908. As depicted, a user selects “England vs Switzerland” as the match, Slovak as the output language, and a “biased” style as the style. A biased style refers to a style written from the perspective of a supporter of a particular team. Different styles are possible.

One of commentary tab 910, facts tab 912, and feed tab 914 can be selected. As depicted, facts tab 912 is selected. Instructions 916 instruct the user to “Pick another fact . . . ” The user selects a fact from fact selector 918, which is optionally previewed in the selector. Then, the system creates output in output panes 820 and 822. As can be seen, the output in output pane 820 is written in a biased style in English, and the output in output pane 822 is written in an biased style Slovak Italian.

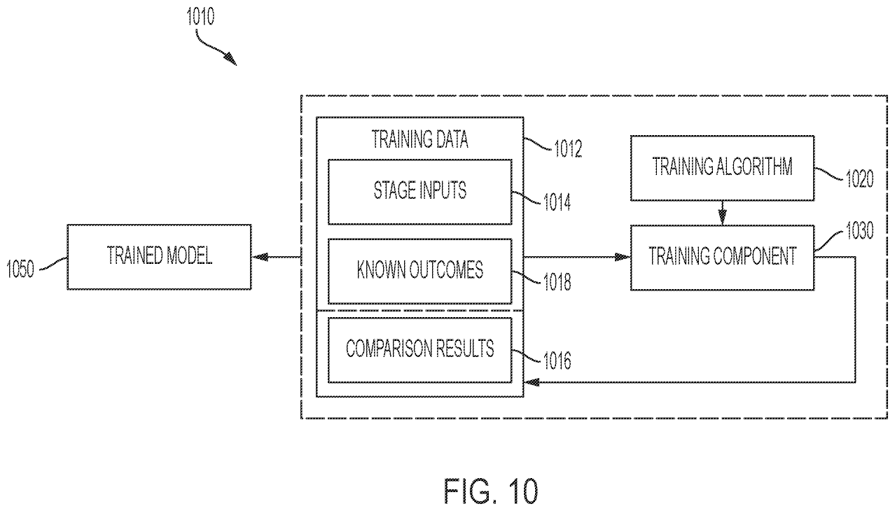

FIG. 10 depicts a flow diagram for training a machine learning model, in accordance with an aspect. As shown in flow diagram 1010 of FIG. 10, training data 1012 may include one or more of stage inputs 1014 and known outcomes 1018 related to a machine learning model to be trained. The stage inputs 1014 may be from any applicable source including a component or set shown in the figures provided herein. The known outcomes 1018 may be included for machine learning models generated based on supervised or semi-supervised training. An unsupervised machine learning model might not be trained using known outcomes 1018. Known outcomes 1018 may include known or desired outputs for future inputs similar to or in the same category as stage inputs 1014 that do not have corresponding known outputs.

The training data 1012 and a training algorithm 1020 may be provided to a training component 1030 that may apply the training data 1012 to the training algorithm 1020 to generate a trained machine learning model 1050. According to an implementation, the training component 1030 may be provided comparison results 1016 that compare a previous output of the corresponding machine learning model to apply the previous result to re-train the machine learning model. The comparison results 1016 may be used by the training component 1030 to update the corresponding machine learning model. The training algorithm 1020 may utilize machine learning networks and/or models including, but not limited to a deep learning network such as GNN, Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 1010 may be a trained machine learning model 1050.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

It should be understood that aspects in this disclosure are exemplary only, and that other aspects may include various combinations of features from other aspects, as well as additional or fewer features.

In general, any process or operation discussed in this disclosure that is understood to be computer-implementable, such as the processes illustrated in the flowcharts disclosed herein, may be performed by one or more processors of a computer system, such as any of the systems or devices in the exemplary environments disclosed herein, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices disclosed herein. One or more processors of a computer system may be included in a single computing device or distributed among a plurality of computing devices. A memory of the computer system may include the respective memory of each computing device of the plurality of computing devices.

FIG. 11 is a simplified functional block diagram of a computer 1100 that may be configured as a device for executing the methods disclosed here, according to exemplary aspects of the present disclosure. For example, the computer 1100 may be configured as a system according to exemplary aspects of this disclosure. In various aspects, any of the systems herein may be a computer 1100 including, for example, a data communication interface 1120 for packet data communication. The computer 1100 also may include a central processing unit (“CPU”) 1102, in the form of one or more processors, for executing program instructions. The computer 1100 may include an internal communication bus 1108, and a storage unit 1106 (such as ROM, HDD, SDD, etc.) that may store data on a computer readable medium 1122, although the computer 1100 may receive programming and data via network communications (e.g., via network 105).

The computer 1100 may also have a memory 1104 (such as RAM) storing instructions 1124 for executing techniques presented herein, for example the methods described with respect to FIGS. 3 and 7, although the instructions 1124 may be stored temporarily or permanently within other modules of computer 1100 (e.g., processor 1102 and/or computer readable medium 1122). The computer 1100 also may include input and output ports 1112 and/or a display 1110 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed aspects may be applicable to any environment, such as a desktop or laptop computer, an automobile entertainment system, a home entertainment system, etc. Also, the disclosed aspects may be applicable to any type of Internet protocol.

It should be appreciated that in the above description of exemplary aspects of the invention, various features of the invention are sometimes grouped together in a single aspect, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed aspect. Thus, the claims following the Detailed Description are hereby expressly incorporated into this Detailed Description, with each claim standing on its own as a separate aspect of this invention.

Furthermore, while some aspects described herein include some but not other features included in other aspects, combinations of features of different aspects are meant to be within the scope of the invention, and form different aspects, as would be understood by those skilled in the art. For example, in the following claims, any of the claimed aspects can be used in any combination.

Thus, while certain aspects have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Operations may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for generating textual summaries using one or more machine learning models, the method comprising:
receiving, from a client device, a request for a summary of one or more sporting events;
accessing, from a database, one or more database records comprising sports related data that is associated with the one or more sporting events;
formulating, from the one or more database records, a machine learning model prompt, wherein the machine learning model prompt comprises (i) instructions readable by the one or more machine learning models and (ii) sports related data from the one or more database records;
providing the machine learning model prompt to the one or more machine learning models;
receiving, from the one or more machine learning models, an initial textual summary of the one or more sporting events;
providing, to an editorial machine learning model, the initial textual summary, wherein the editorial machine learning model is trained to verify the initial textual summary;
receiving, from the editorial machine learning model, a revised textual summary; and
outputting the revised textual summary to the client device.

2. The method of claim 1, further comprising:
providing, to an additional machine learning model, a model text having a style; and
receiving, from the additional machine learning model, a style summary representing the style of the model text; and
providing the style summary to the machine learning model prompt prior to providing the machine learning model prompt to the one or more machine learning models.

3. The method of claim 1, wherein the editorial machine learning model is trained to verify factual accuracy of text, and wherein the editorial machine learning model identifies and corrects one or more factual inaccuracies in the initial textual summary.

4. The method of claim 1, wherein the request comprises preferences for one or more of a length or format of the summary, the method further comprising, adding the preferences to the machine learning model prompt prior to providing the machine learning model prompt to the one or more machine learning models.

5. The method of claim 1, wherein the sports related data comprises tracking data that is generated based on a broadcast feed of the one or more sporting events, wherein the tracking data comprises mathematical representations of one or more of positional information, object information, body pose information, or trend information.

6. The method of claim 1, further comprising identifying, in the database, one or more preferences associated with a user of the client device; and providing the preferences to the machine learning model prompt prior to providing the machine learning model prompt to the one or more machine learning models.

7. The method of claim 1, wherein the request comprises preferences for including a first request for a style and a second request for a length, the method further comprising:
adding the first request and the second request to the machine learning model prompt prior to providing the machine learning model prompt to the one or more machine learning models; and
configuring the editorial machine learning model to verify the style, wherein the revised textual summary is consistent with the style and length.

8. A method for generating textual content using one or more machine learning models, the method comprising:
receiving, from a client device, a request for a translation of sports related data relating to a sporting event, wherein the sports related data is in machine-readable form;
formulating, from the sports related data, a machine learning model prompt, wherein the machine learning model prompt comprises (i) instructions readable by the one or more machine learning models and (ii) the sports related data;
providing the machine learning model prompt to the one or more machine learning models;
receiving, from the one or more machine learning models, textual content corresponding to the sports related data, wherein the textual content is in natural language form; and
outputting the textual content to the client device.

9. The method of claim 8, further comprising:
accessing a translation table that translates the sports related data from a first format to a second format; and
adding the translation table to the machine learning model prompt prior to providing the machine learning model prompt to the one or more machine learning models.

10. The method of claim 9, wherein the first format is Extensible Markup Language (XML) and the second format is a natural language.

11. The method of claim 9, wherein the translation table maps one or more fields relating to sporting events from the first format to the second format.

12. The method of claim 9, further comprising receiving, from a live feed, the sports related data, wherein outputting the textual content is performed in real-time.

13. The method of claim 8, wherein the sports related data comprises tracking data that is generated based on a broadcast feed of the sporting event, the tracking data comprising mathematical representations of one or more of positional information, object information, body pose information, or trend information.

14. A system comprising:
a non-transitory computer readable medium configured to store processor-readable instructions; and
a processor operatively connected to the non-transitory computer readable medium, and configured to execute the processor-readable instructions to perform operations comprising:
receiving, from a client device, a request for a summary of one or more sporting events;
accessing, from a database, one or more database records comprising sports related data that is associated with the one or more sporting events;
formulating, from the one or more database records, a machine learning model prompt, wherein the machine learning model prompt comprises (i) instructions readable by one or more machine learning models and (ii) sports related data from the one or more database records;
providing the machine learning model prompt to the one or more machine learning models;
receiving, from the one or more machine learning models, a textual summary of the one or more sporting events; and
outputting the textual summary to the client device.

15. The system of claim 14, wherein the processor is configured to execute the processor-readable instructions to perform additional operations comprising:
providing, to an additional machine learning model, a model text having a style; and
receiving, from the additional machine learning model, a style summary representing the style of the model text; and
providing the style summary to the machine learning model prompt prior to providing the machine learning model prompt to the one or more machine learning models.

16. The system of claim 14, wherein the processor is configured to execute the processor-readable instructions to perform additional operations comprising providing the textual summary to an editorial machine learning model that is trained to verify factual accuracy of text, identify one or more factual inaccuracies in the textual summary, and correct the one or more factual inaccuracies.

17. The system of claim 14, wherein the request comprises preferences for one or more of a length or format of the summary, wherein the processor is configured to execute the processor-readable instructions to perform additional operations comprising adding the preferences to the machine learning model prompt prior to providing the machine learning model prompt to the one or more machine learning models.

18. The system of claim 14, wherein the sports related data comprises tracking data that is generated based on a broadcast feed of the one or more sporting events, wherein the tracking data comprises mathematical representations of one or more of positional information, object information, body pose information, or trend information.

19. The system of claim 14, wherein the processor is configured to execute the processor-readable instructions to perform additional operations comprising: identifying, in the database, one or more preferences associated with a user of the client device; and adding the preferences to the machine learning model prompt prior to providing the machine learning model prompt to the one or more machine learning models.

20. The system of claim 14, wherein the request comprises preferences for including a first request for a style and a second request for a length, and wherein the processor is configured to execute the processor-readable instructions to perform additional operations comprising:
adding the first request and the second request to the machine learning model prompt prior to providing the machine learning model prompt to the one or more machine learning models; and
configuring an editorial machine learning model to verify that the textual summary is consistent with the style.
